(19) United States
(12) Patent Application Publication
(10) Pub. No.: US 2007/0224584 A1
(43) Pub. Date: Sep. 27, 2007

(54) Apparatus for use in assessing pain level

(76) Inventor: Michelle Hokanson, Magnolia, TX (US)

Correspondence Address: CLARENCE E. ERIKSEN & ASSOCIATES, P.C., NINE GREENWAY PLAZA, SUITE 3100, HOUSTON, TX, 77046-0904, US

(21) Appl. No.: 11/366,704

(22) Filed: Mar. 2, 2006

(51) Int. Cl. G09B 23/28

(52) U.S. Cl. 434/262

(57) ABSTRACT

Apparatus is provided for use in the assessment of pain that a patient is experiencing which comprises a plurality of body pictures of a person of the same gender and ethnicity as the patient, where the body pictures represent different levels of pain for a person of that gender and ethnicity. Apparatus according to the present invention may comprise a plurality of cards having first and second sides. The first side of each card comprises a body picture of a person of the same gender and ethnicity as that of the patient and the body pictures on the plurality of cards represent different levels of pain for a person of the gender and ethnicity of the patient. The second side of each card comprises a pain rating corresponding to the level of pain shown in the body picture on the first side of each card. Apparatus in accordance with the present invention may also take age into account, as well as gender and ethnicity, in determining the patient's pain level. Body pictures generated according to the present invention and the corresponding information relating to pain may be stored in a digital computer and retrieved and displayed in hard copy form or on the display monitor of the computer.

### BACKGROUND OF THE INVENTION

1. Field of the Invention

The present invention relates to apparatus for use in assessing pain levels in patients, and, in particular, apparatus which takes into account the gender and ethnicity of the patient, and which also may take into account the age of the patient.

2. Description of the Prior Art

Diagnosing and treating patients suffering from varying levels of pain are problems that healthcare providers constantly face. Difficulty in properly diagnosing and treating varying levels of pain results from a patient's inability to describe accurately the pain that he/she is experiencing. As a result, a patient's descriptions of pain may sometimes result in ineffective, inadequate or excessive treatments.

Healthcare providers have used varying devices/methods for ascertaining the level of pain that a patient is experiencing. One such device/method has been categorical pain descriptors both verbal and/or numeric, while other devices/methods have employed visual analog scales displaying a scale bearing the same or similar verbal and/or numerical categorical pain descriptors. Once such device is the commonly used “faces of pain” scale, on which a plurality of cartoon faces are displayed. Once the patient identifies the “face” that most accurately represents his/her level of pain, the healthcare provider may then correlate that identification to a pain level and prescribe appropriate medication for the patient.

A shortcoming of the commonly used “faces of pain” scale is that the cartoon faces used contain preassigned expressions and the scale thus assumes that those preassigned expressions will be interpreted by both genders and all ethnic groups as valid indicators for the various levels of pain. The foregoing assumption may be incorrect, and certain ethnic groups, e.g., Hispanics and African-Americans, may not interpret the expressions on the cartoon faces as being associated with pain, with the result being that these ethnic groups may not be receiving adequate treatment for pain. Further, the face on the faces of pain scale associated with maximum pain is crying. A patient whose culture does not accept crying may never pick that face even though he/she has maximum pain, but instead may pick another face, with the result that the patient would be under-medicated for pain.

The applicant has also discovered that the age of the patient may also be important in assessing the patient's pain, and the faces of pain scale, for example, does not take the patient's age into consideration. The applicant has observed that patients from older generations may have difficulty in quantifying their pain levels.

### SUMMARY OF THE INVENTION

In accordance with the present invention, apparatus is provided for use in the assessment of pain that a patient is experiencing. Apparatus in accordance with the present invention comprises a plurality of body pictures of the same gender and ethnicity of the patient. The body pictures represent different levels of pain for a person of the same gender and ethnicity as that of the patient. A pain rating is associated with each of the body pictures.

In one embodiment, apparatus in accordance with the present invention comprises a plurality of cards having first and second sides. The first side of each said card comprises a body picture of a person of the same gender and ethnicity as that of the patient, and the body pictures on the plurality of cards represent different levels of pain for a person of the gender and ethnicity of the patient. The second side of each card comprises a pain rating corresponding to the level of pain associated with the body picture on the first side of each card.

In one specific embodiment, apparatus in accordance with the present invention may comprise four cards for use with a male, African-American patient. In this embodiment, the first card comprises a body picture of an African-American man who is smiling and seated, and the body picture on this card represents a zero pain level. In this first embodiment, a second card contains a body picture of the same man standing with his arms folded, and the man is neither smiling nor frowning. This picture represents that the man is experiencing a mild level of pain. In this first embodiment, a moderate level of pain is represented by the body picture of the man on the first side of a third card sitting with his left elbow on his left thigh and his head in his left hand. Severe pain is represented in this first embodiment by a body picture of the man on the first side of a fourth card, who is in a seated position, grasping his knee with an expression of pain on his face.

In a second specific embodiment, apparatus in accordance with the present invention may comprise four cards for use with a female, Hispanic patient. In this embodiment, the first card contains a body picture of a Hispanic woman who is standing with her hands lying flat on a table in front of her, and this body picture represents zero pain. In this second embodiment, mild pain is illustrated on the first side of a second card by a body picture of the same woman curled up in a chair with a cover around her. In this second embodiment, moderate pain may be illustrated on the first side of a third card by a body picture of the woman lying on a bed with her hands under her head and on a pillow. In this second embodiment, a fourth card contains a body picture of the woman lying on a bed and covered by a blanket, and this body picture represents a severe level of pain.

An embodiment of apparatus in accordance with the present invention may comprise a digital computer in which body pictures are stored which represent various levels of pain according to gender, ethnicity and/or age. The body pictures may, for example, be stored in the digital computer by scanning photographs of persons of different ethnicities, genders and/or ages. The levels of pain corresponding to those stored body pictures may also be inputted into the digital computer. When the ethnicity, gender and/or age of the patient is entered into the computer, body pictures and pain levels corresponding to those body pictures may be retrieved and viewed, either in hard copy form or on a the display monitor of the computer.

### BRIEF DESCRIPTION OF THE DRAWINGS

In the accompanying drawings:

FIG. 1 is a plurality of plan views of the fronts and backs of cards according to one specific embodiment of the present invention.

FIG. 2 is a plurality of plan views of the fronts and backs of cards according to one specific embodiment of the present invention.

FIG. 3 is a perspective view of a digital computer in which information respecting body pictures illustrating various levels of pain for different ethnic and gender groups may be stored and from which such information may be retrieved and displayed.

### DESCRIPTION OF SPECIFIC EMBODIMENTS

It will be appreciated that the present invention may take many forms and embodiments. Some embodiments of the invention are described so as to give an understanding of the invention. The description herein is thus intended to illustrate and not to limit the invention.

The applicant has determined that body language of a patient is extremely important in assessing the level of pain that a patient is experiencing. The foregoing is especially true in the case of minority patients, e.g. Hispanics and African-Americans, who may have the propensity not to express pain or if they do, to express it primarily through body language and not through facial expressions.

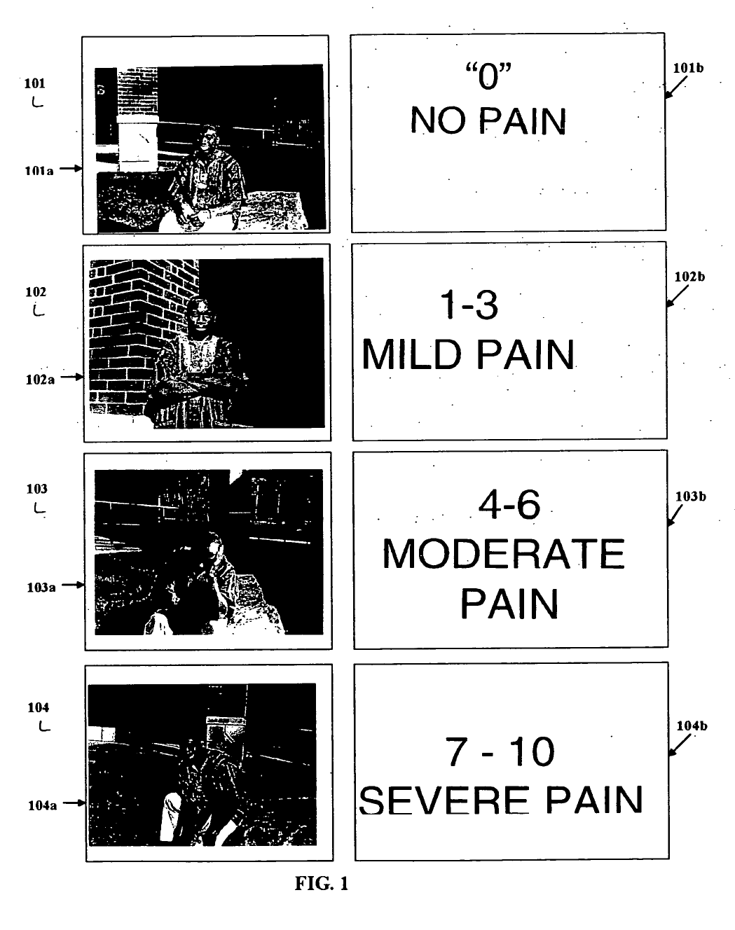

With reference first to FIG. 1, apparatus in accordance with the present invention comprises a plurality of cards 101, 102, 103 and 104. The front sides of cards 101-104 are designated as 101a-104a, respectively. These front sides 101a-104a contain body pictures of a person having the same gender and ethnicity as the patient. The front sides 101a-104a shown in FIG. 1 contain body pictures of an African-American male.

The backsides of the cards 101-014 illustrated in FIG. 1 are designated 101b-104b, respectively. Printed on the backsides of each card 101-104 are levels of pain associated with the body picture on the front side of the card.

The applicant has determined that body language of a patient is extremely important in assessing the level of pain that a patient is experiencing. The foregoing is especially true in the case of minority patients, e.g. Hispanics and African-Americans, who may have the propensity not to express pain and if they do, to express it primarily through body language and not through facial expression.

For example, in the specific embodiment of the present invention illustrated in FIG. 1, the front side 101a of card 101 contains a photograph of an African-American male who is seated and smiling. The level pain associated with this photograph is no pain, as illustrated on the second side 101b of card 101. Still with reference to FIG. 1, card 102 has a front side containing a picture of the same African-American male as in card 101. In card 102, however, the man is standing with his arms crossed and he has a facial expression which is neither smiling nor frowning. The second side 102b of card 102 contains information that this body expression is associated with a mild pain.

Still referring to FIG. 1, moderate pain for the same African-American male is illustrated in the photograph on the front side 103a of card 103. In this photograph, the African-American male is seated with his head in his left hand.

Finally, if the African-American shown in the cards of FIG. 1 is experiencing severe pain, that pain is indicated by the picture of the male shown on the first side 104a of card 104. In this photograph, the African-American male is seated and is grasping his left knee with both hands and is gritting his teeth.

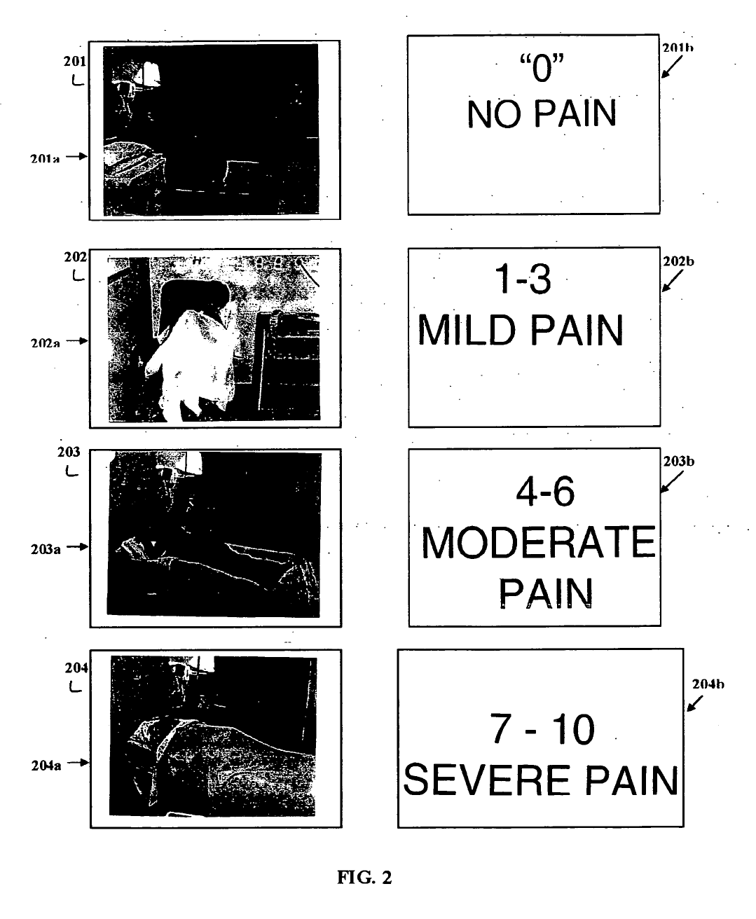

With reference to FIG. 2, another specific embodiment of apparatus in accordance with the present invention is illustrated. This embodiment also comprises a plurality of cards 201-204 with the front sides of cards 201-204 being designated as 201a-204a, respectively. The cards illustrated in FIG. 2 are for use with a female Hispanic patient. In this embodiment, the front side 201a of first card 201 comprises a body picture of a Hispanic woman who is standing with a table in front of her and her lands laying flat the table. This body picture represents zero pain as indicated on the second side 201b of card 201. In this embodiment of the present invention shown in FIG. 2, the first side 202a of card 202 comprises a body picture of the same woman as in card 201 who is now curled up in a chair with a cover around her. This body picture represents mild pain as indicated on the second side 202b of card 202.

In this embodiment of the present invention shown in FIG. 2, moderate pain may be illustrated by a third card 203 having a body picture on the first side 203a of the woman lying on a bed with her hands under her head and on a pillow. Finally, a fourth card 204 comprises a first side 204a containing a body picture of the woman lying on a bed and covered by a blanket, and this body picture represents a severe level of pain, as indicated on the second side 204b of card 204.

The body pictures that are illustrated in FIGS. 1 and 2 and their corresponding pain levels are arrived at by interviewing and studying a substantial number of persons of each gender and ethnic group to determine the body language used by that gender and ethnic group to indicate various levels of pain. The age of the persons interviewed and studied may also be taken into account to determine the extent to which body language relating to pain is also affected by age. Accordingly, an embodiment of the present invention may also comprise a plurality of cards to be used based on the ethnicity, gender and age of the patient.

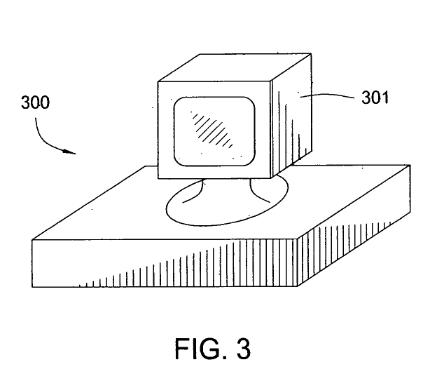

Referring to FIG. 3, once the body pictures and corresponding pain levels are established for different ethnic, gender and/or age groups, that information may be stored in a digital computer 300 using techniques to those skilled in the art of computers and their programming. Such techniques may, for example, utilize well-known scanning methods. The body pictures stored in the computer 300 pertaining to the ethnicity, gender and/or age of a patient may be accessed, and the patient may be shown that those body pictures, for example, by viewing a hard copy or by viewing the information on the display monitor 301 associated with the computer 300.

As used in this specification, the term “body picture” is intended to mean any pictorial representation of the whole or part of the body of a patient, and in one embodiment, a body picture may comprise a photograph of the patient as illustrated on the first sides of the cards in FIGS. 1 and 2.

What is claimed is:

1. Apparatus for use in the assessment of pain that a patient is experiencing, comprising a plurality of different body pictures of a person of the same gender and ethnicity as that of the patient, the body pictures representing different levels of pain for a person of the gender and ethnicity of the patient.

2. The apparatus of claim 1, wherein it comprises a plurality of cards having first and second sides, each body picture is contained on a first side of a two-sided card and wherein the second side of each card contains a pain rating corresponding to the level of pain associated with the body picture on the first side of the card.

3. The apparatus of claim 1, wherein it comprises four cards for use with a male, African-American patient and wherein:
(a) the first side of the first card comprises a photograph of an African-American male who is seated and smiling;
(b) the first side of the second card comprises a photograph of an African-American male who is standing with his arms crossed and who is neither smiling nor frowning;
(c) the first side of the third card comprises a photograph of an African-American male who is seated with his head in one of his hands; and
(d) the first side of the fourth card comprises of an African-American male who is seated and grasping one of his knees and gritting his teeth;

4. The apparatus of claim 3, wherein the second sides of the first, second, third and fourth cards contain pain ratings of no pain, mild pain, moderate pain and severe pain, respectively.

5. The apparatus of claim 2, wherein it comprises four cards for use with a female, Hispanic patient and wherein:
(a) the first side of the first card comprises a photograph of a Hispanic woman who is standing with her hands laying flat on a table which is in front of her;
(b) the first side of the second card comprises a photograph of a Hispanic woman who is curled up in a chair with a cover around her;
(c) the first side of the third card comprises a photograph of a Hispanic woman with her hands on her head and on a pillow; and
(d) the first side of the fourth card comprises a photograph of a Hispanic woman lying on a bed and covered by a blanket.

6. The apparatus of claim 5, wherein the second sides of the first, second, third and fourth cars contain pain ratings of no pain, mild pain, moderate pain and severe pain, respectively.

7. The apparatus of claim 1, wherein it comprises a digital computer in which the body picture and the level of pain corresponding to each body picture are stored.
